(19) United States
(12) Patent Application Publication
(10) Pub. No.: US 2004/0105387 A1
(43) Pub. Date: Jun. 3, 2004

(54) Router apparatus

(76) Inventor: Takashi Sakakura, Tokyo (JP)

Correspondence Address: BIRCH STEWART KOLASCH & BIRCH, PO BOX 747, FALLS CHURCH, VA, 22040-0747, US

(21) Appl. No.: 10/703,629

(22) Filed: Nov. 10, 2003

(30) Foreign Application Priority Data
Nov. 11, 2002 (JP) 2002-327340

(51) Int. Cl. H04L 12/26

(52) U.S. Cl. 370/232

(57) ABSTRACT

An access router for connecting a wireless LAN base station to the Internet is provided with an IP packet identification unit for identifying IP packets that are burstly transmitted to the router apparatus based on both a protocol for a transport layer, which is applied to received IP packets, and a transfer rate at a time of receiving IP packets, and for disabling a transfer of received IP packets that are determined to be burstly transmitted to the router apparatus, and a transfer rate measurement unit for determining the transfer rate.

### BACKGROUND OF THE INVENTION

1. Field of the Invention

The present invention relates to a router apparatus that is an intermediate system for an IP network.

2. Description of Related Art

Recently, a technology that is called wireless LAN (Local Area Network) has been widely available, and demand for use of internet access services by using a wireless LAN has risen rapidly not only in offices but also at various places. For example, in a public space such as a railway station or a lobby at a hotel, such a technology can provide a high-speed data access as compared with mobile phones and PHS (Personal Handyphone System) phones.

At present, widely-spread Wireless LANs are based on the standard “IEEE802.11b”. IEEE802.11b adopts a media access protocol that is called CSMA/CA (Carrier Sense Multiple Access with Collision Avoidance). In accordance with CSMA/CA, all devices including base stations are on an equality with one another in a shared wireless band, each of them monitors a sending of a carrier signal, and any one of the devices can send out a signal as long as a collision does not occur. A system based on IEEE802.11b can have a communication range of about 100 m or less, and can transfer data at a transfer rate of up to 11 Mbps. In general, it is preferable that one base station that is placed indoors can provide services for about 10 users at the same time. Such a system based on IEEE802.11b can have a data transfer ability to such an extent that it can provide services for all users even if they perform transmission of electronic mails, WEB access, or speech communications.

However, in accordance with CSMA/CA, because there is no limitation imposed on the amount of transmitted data, when a user makes a wireless terminal perform a file transfer according to FTP (File Transfer Protocol), for example, the wireless terminal performs a burst transmission for transferring data together if the network has a sufficiently high transfer rate and this results in an occurrence of situation in which the single burst transmission occupies most of the wireless band. Therefore, although a system based on IEEE802.11b originally has a data transfer rate of up to 11 Mbps and has an ability of maintaining more than ten communication sessions each having a transfer rate that is nearly equal to those of modems, there can be an occurrence of a situation in which if one of wireless terminals performs burst transmission, any other wireless terminal enters a state in which it cannot communicate with other terminals and therefore cannot receive services.

A prior art communication traffic management method of evaluating traffic including burst transmission as a measure of additional installation of telecommunications equipment or the like has been provided (refer to Japanese patent application publication (TOKKAI) No. 2002-118557 (FIG. 5), for example).

As mentioned above, a problem with a wireless LAN according to CSMA/CA, for example, is that because there is no limitation imposed on the amount of transmitted data, there is a possibility that when a terminal performs burst transmission, any other terminal falls into a state in which it cannot communicate with other terminals even though it originally has a sufficient transferring ability.

### SUMMARY OF THE INVENTION

The present invention is proposed to solve the above-mentioned problem, and it is therefore an object of the present invention to provide a router apparatus that disables burst transmission and provides services for users without partiality.

In accordance with the present invention, there is provided a router apparatus including an IP packet identification unit for identifying IP packets that are burstly transmitted to the router apparatus based on both a protocol for a transport layer, which is applied to received IP packets and a transfer rate at a time of receiving IP packets, and for disabling a transfer of received IP packets that are determined to be burstly transmitted to the router apparatus, and a transfer rate measurement unit for determining the transfer rate.

Therefore, the router apparatus disables burst transmission of IP packets and makes it possible to provide services for users without partiality. Particularly, the router apparatus is effective for internet access services using a wireless LAN, for example.

Further objects and advantages of the present invention will be apparent from the following description of the preferred embodiments of the invention as illustrated in the accompanying drawings.

### BRIEF DESCRIPTION OF THE DRAWINGS

FIG. 1 is a diagram showing the configuration of a network where a router apparatus in accordance with embodiment 1 of the present invention is placed;

FIG. 2 is a block diagram showing the structure of the router apparatus in accordance with embodiment 1 of the present invention;

FIG. 3 is a flow chart of a process of identifying IP packets which is performed by an IP packet identification unit;

FIG. 4 is a diagram showing the structure of a statistical information table;

FIG. 5 is a flow chart of a part of a measurement process which is performed by a data transfer rate measurement unit;

FIG. 6 is a flow chart of a process of processing IP packets to which TCP is applied;

FIG. 7 is a flow chart of a process of processing IP packets to which RTP is applied;

FIG. 8 is a flow chart of a process of processing IP packets to which UDP is applied; and

FIG. 9 is a flow chart of a process of resetting a TCP predetermined value.

### DETAILED DESCRIPTION OF THE PREFERRED EMBODIMENTS

The preferred embodiments of the invention will now be described with reference to the accompanying drawings.

Embodiment 1.

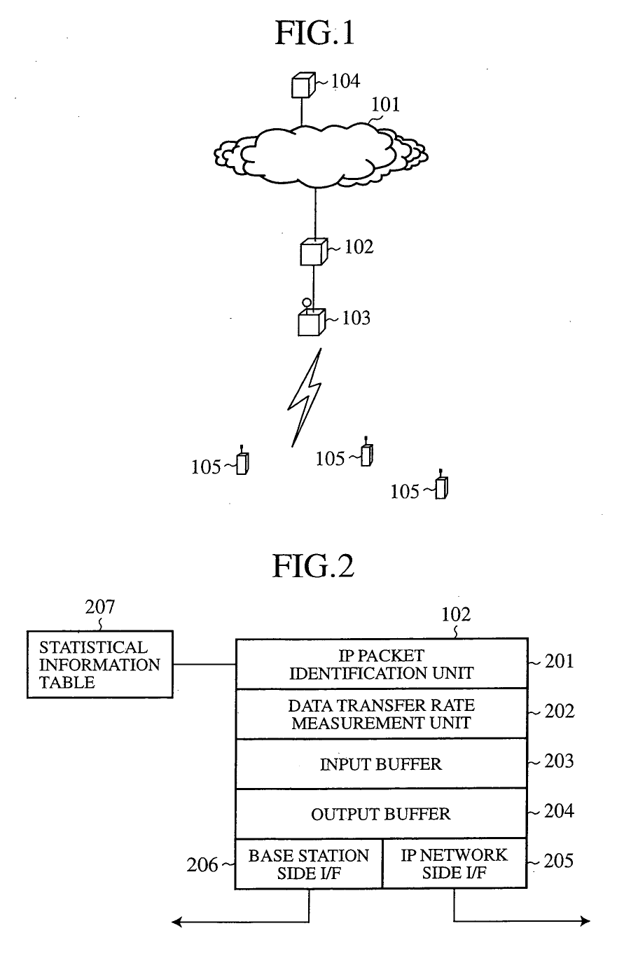

FIG. 1 is a diagram showing the configuration of a network where a router apparatus in accordance with embodiment 1 of the present invention is placed. A wireless LAN base station 103 (i.e., a radio base station) is connected to the Internet 101 by way of the access router 102 (i.e., the router apparatus). Each mobile terminal 105 is a terminal that can be connected to a wireless LAN, and is connected to the Internet 101 by way of the wireless LAN base station 103. Each mobile terminal 105 can access an FTP (File Transfer Protocol) server 104 similarly connected to the Internet 101, and performs a file transfer by using the FTP server 104.

FIG. 2 is a block diagram showing the structure of the access router 102 in accordance with embodiment 1 of the present invention. The access router 102 connects with the wireless LAN base station 103 by way of a base station side interface 206 thereof. The access router 102 also connects with the Internet 101 by way of an IP network side interface 205 thereof. Each of the base station side interface 206 and the IP network side interface 205 uses 100BaseTX Ethernet (registered trademark).

IP packets that are received by the access router 102 by way of the IP network side interface 205 and the base station side interface 206 are stored in an input buffer 203. The input buffer 203 uses a queue for queuing the received IP packets one by one. An IP packet identification unit 201 examines the transfer rate of each received IP packet queued by the input buffer 203, and then delivers each received IP packet to an output buffer 204. The transfer rate of each received IP packet is calculated by a data transfer rate measurement unit 202 (i.e., a transfer rate measurement unit). The IP packet identification unit 201 determines whether or not each received IP packet is an IP packet that has been burstly transferred to the access router. Then, when determining that each received IP packet has been burstly transferred, the IP packet identification unit 201 disables the output of each received IP packet to the output buffer 204 by discarding each received IP packet, for example.

The output buffer 204 uses queues and is provided with a buffer for use with the base station side interface 206, for queuing IP packets to be transmitted to the wireless LAN base station 103, and a buffer for use with the IP network side interface 205, for queuing IP packets to be transmitted to the Internet 101. Each of IP packets queued by the output buffer 204 is sent to a corresponding one of the interfaces 205 and 206 one by one according to priorities assigned to them.

A statistical information table 207 stores the amount of transferred data associated with a session under execution (i.e., a target session), information about the transfer rate, and so on.

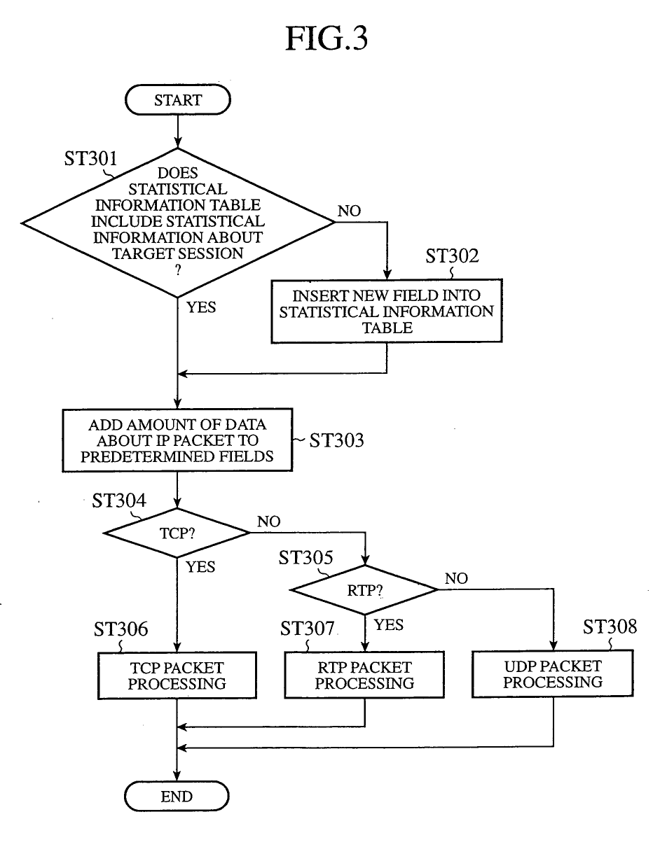

Next, a method of processing IP packets queued by the input buffer 203 in the access router 102 will be explained. FIG. 3 is a flow chart of a process of identifying IP packets which is performed by the IP packet identification unit 201. First of all, the IP packet identification unit 201 checks to see whether each of IP packets to be processed, which are queued by the input buffer 203, has a statistical information storage field for storing statistical information about the session in question with reference to the statistical information table 207 (in step ST301).

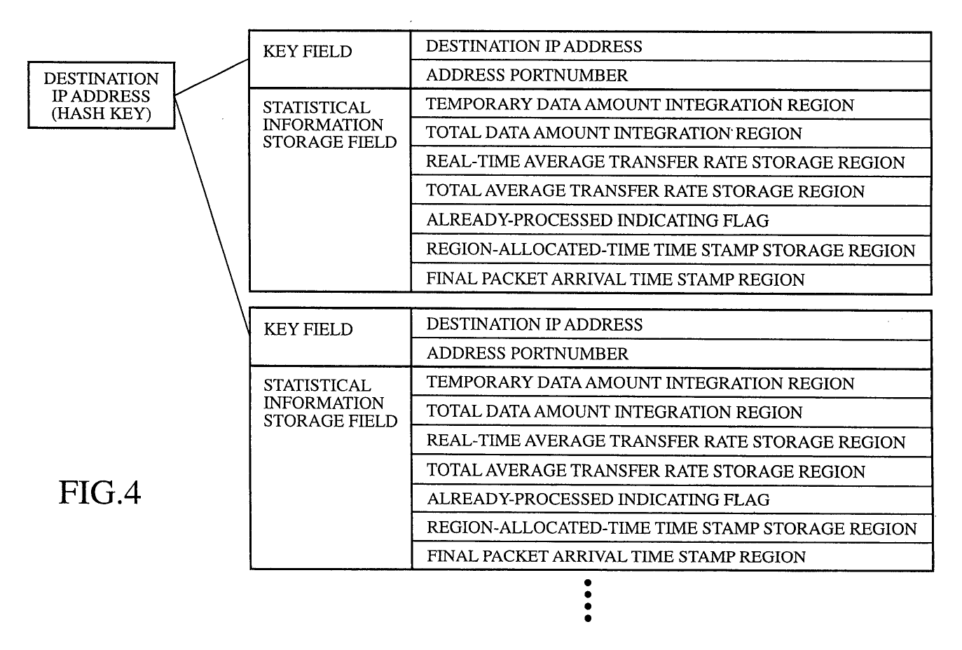

FIG. 4 is a diagram showing the structure of the statistical information table 207. As shown in the figure, in the statistical information table 207, each of destination IP addresses specified by IP packets is defined as a hash key, and statistical information storage fields each of which is provided for a session identified by a destination IP address and an address portnumber are held. Each statistical information storage field contains “Temporary data amount integration region”, “Total data amount integration region”, “Real-time average transfer rate storage region”, “Total average transfer rate storage region”, “Already-processed indicating flag”, “Region-allocated-time time stamp storage region”, and “Final packet arrival time stamp region”. “Temporary data amount integration region” holds the amount of IP packet data associated with the session in question, which are transferred per unit time, and “Total data amount integration region” holds the amount of data which have been transferred since the first IP packet associated with the session was received. “Real-time average transfer rate storage region” stores a data transfer rate per unit time that is calculated by the data transfer rate measurement unit 202, and “Total average transfer rate storage region” stores a total average data transfer rate that is an average of data transfer rates that have been measured since the session was started. “Already-processed indicating flag” shows whether, in the case of a TCP session, at least one IP packet associated with the TCP session has been discarded. “Region-allocated-time time stamp storage region” records a time when the first IP packet associated with the session was received by the access router 102, and “Final packet arrival time stamp region” records a time when the last IP packet associated with the session was received by the access router 102.

When determining that no statistical information storage field associated with the session in question exists in step ST301, the IP packet identification unit 201 inserts an initialized statistical information storage field for the session in question in the statistical information table 207 (in step ST302).

When determining that a statistical information storage field associated with the session in question exists in step ST301, the IP packet identification unit 201 adds the amount of data about a target IP packet received to each of “Temporary data amount integration region” and “Total data amount integration region”. Furthermore, the IP packet identification unit 201 stores the time of arrival of the target IP packet in “Final packet arrival time stamp region” (in step ST303).

The IP packet identification unit 201 then determines which transport protocol is applied to the target IP packet (in steps ST304 and ST305). The IP packet identification unit 201 performs a TCP packet process when determining that TCP (Transmission Control Protocol) is applied to the target IP packet (in step ST306). The IP packet identification unit 201 performs a RTP packet process when determining that RTP (Real-time Transport Protocol) is applied to the target IP packet (in step ST307). The IP packet identification unit 201 performs a UDP (User Datagram Protocol) packet process otherwise (in step ST308). The details of each of the above-mentioned processes will be described later.

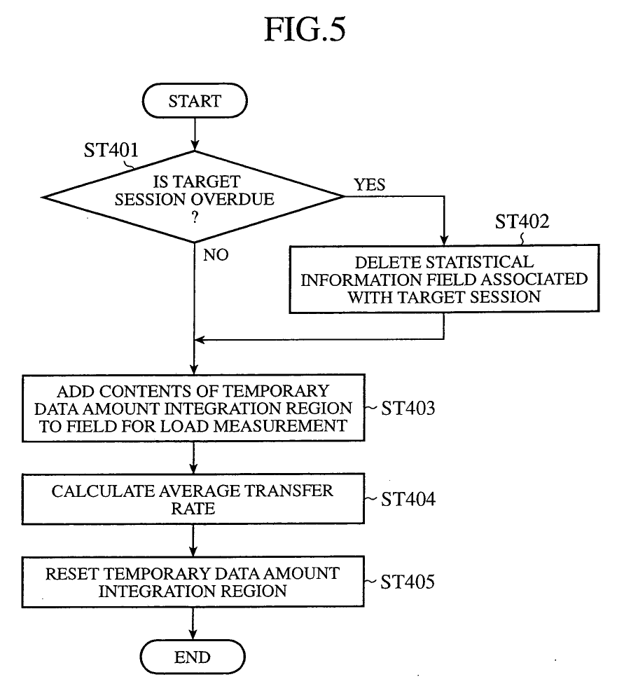

FIG. 5 is a flow chart of a part of a measurement process which is performed by the data transfer rate measurement unit 202 every one second. This process is performed on the statistical information storage field associated with each session which is stored in the statistical information table 207. First of all, the data transfer rate measurement unit 202 determines whether 20 or more seconds have elapsed since the last packet associated with a session in question was received with reference to “Final packet arrival time stamp region” in the statistical information storage field (in step ST401).

The data transfer rate measurement unit 202 deletes the statistical information field associated with the session in question because it falls due when determining that 20 seconds have elapsed in step ST401 (in step ST402).

In contrast, when determining that 20 seconds have not elapsed in step ST401, the data transfer rate measurement unit 202 adds the content stored in “Temporary data amount integration region” of the statistical information field associated with the session in question to a field for load measurement which is disposed in the router. The data transfer rate measurement unit 202 then increments the number of effective sessions also stored in the router by one (in step ST403).

The data transfer rate measurement unit 202 then calculates a real-time average transfer rate associated with the session in question from the amount of data stored in “Temporary data amount integration region”, and stores the real-time average transfer rate in “Real-time average transfer rate storage region” (in step ST404).

In addition, in order to calculate a real-time average of transfer rates for the next one second, the data transfer rate measurement unit 202 resets “Temporary data amount integration region” to “0” (in step ST405).

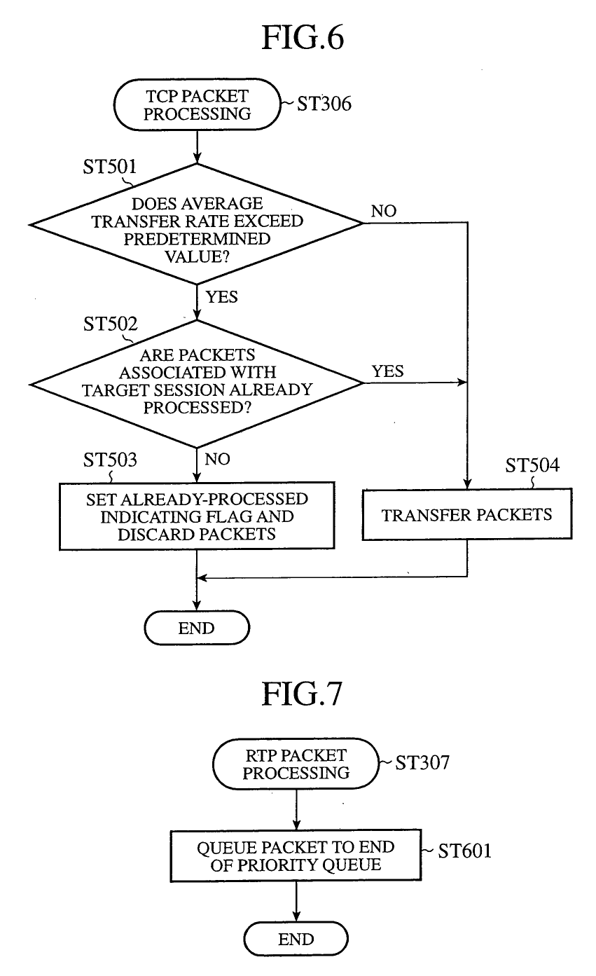

Next, the TCP packet process (refer to step ST306 and FIG. 3) will be explained with reference to the flow chart of FIG. 6. First of all, the IP packet identification unit 201 checks to see whether the real-time average transfer rate exceeds a predetermined value with reference to “Real-time average transfer rate storage region” associated with the session in question. A fixed value is set to the predetermined value (in step ST501).

When determining that the real-time average transfer rate exceeds the know value in step ST501, the IP packet identification unit 201 refers to “Already-processed indicating flag” of the statistical information storage field associated with the session in question (in step ST502). “Already-processed indicating flag” indicates whether the router apparatus has discarded IP packets associated with the session in question.

When determining that the value of the flag indicates “False” in step ST502, the IP packet identification unit 201 discards the received IP packet in question and sets “Already-processed indicating flag” to “Truth” (in step ST503).

On the other hand, when determining that the real-time average transfer rate doesn't reach the predetermined value in step ST501, or when determining that “Already-processed indicating flag” is “Truth” in step ST502, the IP packet identification unit 201 queues the received IP packet in question into the output buffer 204 and then transfers IP packets queued in the output buffer one by one (in step ST504).

Thus, because the router apparatus discards IP packets when the real-time average transfer rate exceeds the predetermined value (i.e., in the case of burst transmission), each mobile terminal 105 is enabled to adjust the transfer rate of TCP data. In other words, each mobile terminal 105 can adjust the transfer rate of TCP stacks and therefore the occupation of a specific terminal in the radio communication band can be prevented.

In the case of communications with a very large amount of data transfer, the IP packet identification unit 201 uses the contents of “Total average transfer rate storage region” instead of those of “Real-time average transfer rate storage region”. The contents of “Total average transfer rate storage region” are calculated by dividing the contents of “Total data amount integration region” by a time that has elapsed from the time stored in “Region-allocated-time time stamp storage region” to the current time.

Next, a process of processing IP packets to which RTP is applied (refer to step ST307 and FIG. 3) will be explained with reference to a flow chart of FIG. 7. RTP is a transport protocol for use in streaming reproduction, voice communications and so on which use IP packets. IP packets according to RTP are queued by a priority queue of the output buffer 204 (in step ST601). As a result, RTP packets can be passed through the access router 102 on a priority basis.

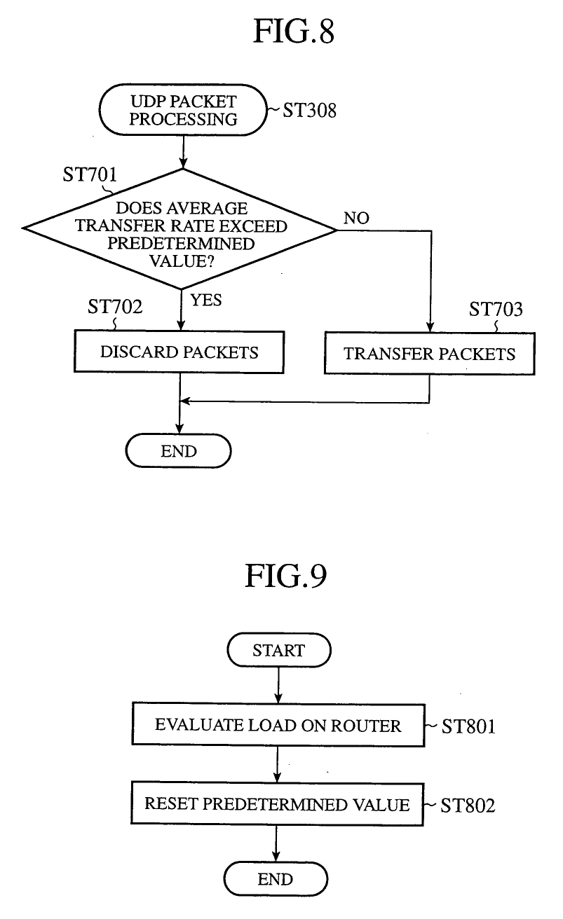

Next, a process (refer to step ST308 and FIG. 3) that is performed by the router apparatus when receiving IP packets to which UDP is applied will be explained with reference to a flow chart of FIG. 8. An NFS (network file system) is known as a general application that uses UDP. Furthermore, UDP is also used by an application such as an authentication session.

First of all, the IP packet identification unit 201 checks to see whether the real-time average transfer rate associated with the session in question exceeds a predetermined value (in step ST701). Here, a fixed value is set to the predetermined value.

When determining that the real-time average transfer rate associated with the session in question exceeds the predetermined value in step ST701, the IP packet identification unit 201 discards the IP packet in question (in step ST702).

When determining that the real-time average transfer rate associated with the session in question doesn't exceed the predetermined value in step ST701, the IP packet identification unit 201 queues the IP packet in question into the output buffer 204 and then transfers IP packets queued in the output buffer one by one (in step ST703).

When an application that uses the session in question has a function of re-sending packets, the router apparatus can transmit packets if the real-time average transfer rate falls to the predetermined value or below again. When a wireless terminal repeats UDP transmission/re-sending, the advantage of preventing occupation of a specific terminal in the radio communication band is weakened. However, because it is assumed that the sending side mainly uses a cable network when re-sending is carried out for UDP transmission, occupation of a specific terminal in the radio communication band can be actually prevented.

As mentioned above, in accordance with this embodiment 1, because the IP packet identification unit identifies IP packets that are burstly transmitted to the router apparatus based on the protocol for the transport layer that is applied to IP packets queued into the input buffer 203 and the real-time average transfer rate calculated by the data transfer rate measurement unit 202 and disables a transfer of the IP packets, the router apparatus can prevent services from being provided for users partially due to burst transmission in internet access services using a wireless LAN.

In addition, in accordance with this embodiment 1, because the router apparatus properly discards IP packets to which TCP is applied when the real-time average transfer rate exceeds a predetermined value, a terminal that is the sending source of the IP packets can have a transport mechanism of adjusting the transfer rate.

Furthermore, in accordance with this embodiment 1, because the router apparatus discards all following IP packets to which UDP is applied and which are associated with the session in question when the real-time average transfer rate exceeds the predetermined value, the router apparatus can prevent the radio communication band from being occupied by burst transmission according to UDP.

In addition, in accordance with this embodiment 1, because the router apparatus transfers IP packets to which RTP is applied on a priority basis, the router apparatus can prevent communications according to RTP from being obstructed by burst transmission caused by an application using TCP or UDP. Furthermore, in accordance with this embodiment 1, because the data transfer rate measurement unit 202 calculates the transfer rate of IP packets only for a session in which the time required for the reception of IP packets doesn't exceed a constant time limit, the session being included in sessions identified by the sending source IP address, the destination IP address, and the address portnumber, the router apparatus can eliminate the need for processing sessions that end in communications failure.

Because the router apparatus in accordance with the present invention adjusts the amount of data transfer and disables burst transmission by using an existing transport mechanism, the router apparatus is not suitable for a wireless system in which a band ensuring mechanism is provided, such as a system examined according to IEEE802.ee e or the like, but suitable for a CSMA wireless system that has been already widespread.

In a variant of embodiment 1, the access router can connect a cable LAN with the IP network, instead of connecting the wireless LAN base station with the IP network.

Embodiment 2.

In a router apparatus in accordance with embodiment 2, a data transfer rate measurement unit 202 can dynamically reset a TCP predetermined value of a real-time average transfer rate of IP packets to which TCP is applied. FIG. 9 is a flow chart of a process of resetting the TCP predetermined value. The following logic is implemented as part of a measurement process which is performed by the data transfer rate measurement unit 202 every one second.

First of all, a load imposed on the access router 102 is evaluated. Concretely, the data transfer rate measurement unit 202 acquires the number of effective sessions for each of protocols stored in the access router 102 (in step ST801). The data transfer rate measurement unit 202 calculates and resets the TCP predetermined value based on the number of effective sessions acquired in step ST801 (in step ST802) according to the following equation:

TCP predetermined value (kbps)=(a−b* number of RTP sessions)/number of TCP sessions

Next, the equation will be explained. a is an effective value of a band via which data can be transferred, the band being included in the communications band. A band for RTP sessions that are transferred on a priority basis is subtracted from this value. b is a band required for one RTP session. The data transfer rate measurement unit 202 calculates an upper limit of transfer rates that can be provided for one TCP session by dividing a remaining band that is obtained by subtracting the band assigned to RTP sessions (i.e., b*the number of RTP sessions) from the effective value a of the band via which data can be transferred by the number of TCP sessions. When devices based on IEEE802.11b are used, for example, the effective value (a) that is obtained by subtracting the amount of overhead from a maximum data transfer rate 11 Mbps becomes about 6000 kbps. The band (b) required for one session of voice communications using RTP is about 100 kbps, for example.

As mentioned above, the router apparatus in accordance with embodiment 2 can dynamically reset the predetermined value of the real-time average transfer rate of IP packets to which TCP is applied based on the number of effective sessions stored therein, the router apparatus can reset the predetermined value according to communication conditions.

Embodiment 3.

In a router apparatus in accordance with embodiment 3, a data transfer rate measurement unit 202 can dynamically reset a TCP predetermined value of a real-time average transfer rate of IP packets to which TCP is applied, as in the case of that of embodiment 2. In accordance with embodiment 3, the data transfer rate measurement unit 202 uses a throughput value of the access router 102 in order to evaluate a load imposed on the access router 102. Concretely, the data transfer rate measurement unit 202, in step ST801 of FIG. 9, acquires a field value for load measurement, which is stored in the access router 102, and, in step ST802, calculates and resets the TCP predetermined value by using the following equation:

TCP predetermined value (kbps)=(a−field value for load measurement)* c

Next, the equation will be explained. In accordance with embodiment 2, the data transfer rate measurement unit 202 subtracts a band for RTP sessions from an effective value (a) for a band via which data can be transferred. In contrast, in accordance with embodiment 3, the data transfer rate measurement unit 202 uses a value which is obtained by subtracting the total amount of transferred data stored in the access router 102, which is stored in the field for load measurement, from the effective value (a). By assigning a weight (c) to this subtraction result, the data transfer rate measurement unit 202 can appropriately calculate the predetermined value according to the traffic condition of communications. When devices based on IEEE802.11b are used, as in the case of embodiment 2, 0.5 can be set to the value of c. After the predetermined value is reset, the value stored in the field for load measurement is initialized to 0.

As mentioned above, the router apparatus in accordance with embodiment 3 can dynamically reset the predetermined value of the real-time average transfer rate of IP packets to which TCP is applied based on the amount of transferred data stored therein, the router apparatus can reset the predetermined value according to communication conditions.

Many widely different embodiments of the present invention may be constructed without departing from the spirit and scope of the present invention. It should be understood that the present invention is not limited to the specific embodiments described in the specification, except as defined in the appended claims.

What is claimed is:

1. A router apparatus comprising: an IP packet identification unit for identifying IP packets that are burstly transmitted to said router apparatus based on both a protocol for a transport layer, which is applied to received IP packets, and a transfer rate at a time of receiving IP packets, and for disabling a transfer of received IP packets that are determined to be burstly transmitted to said router apparatus; and a transfer rate measurement unit for determining said transfer rate.

2. The router apparatus according to claim 1, wherein in a case of receiving IP packets to which TCP is applied as the protocol for the transport layer, said IP packet identification unit discards said IP packets so as to cause a terminal that is a sending source of said IP packets to adjust the transfer rate to a predetermined value or below when the transfer rate at the time of receiving said IP packets exceeds the predetermined value.

3. The router apparatus according to claim 1, wherein in a case of receiving IP packets to which UDP is applied as the protocol for the transport layer, said IP packet identification unit discards all IP packets associated with an identical session when the transfer rate at the time of receiving said IP packets exceeds a predetermined value.

4. The router apparatus according to claim 1, wherein said IP packet identification unit transfers IP packets to which RTP is applied as the protocol for the transport layer on a priority basis, and disables a transfer of IP packets to which other protocols are applied.

5. The router apparatus according to claim 1, wherein said transfer rate measurement unit calculates the transfer rate only for sessions in which a time required for reception of preceding IP packets does not exceed a predetermined time.

6. The router apparatus according to claim 2, wherein said transfer rate measurement unit dynamically sets the predetermined value based on a number of sessions stored in said router apparatus.

7. The router apparatus according to claim 2, wherein said transfer rate measurement unit dynamically sets the predetermined value according to an amount of transferred data stored in said router apparatus.
